(19) United States
(12) Patent Application Publication
(10) Pub. No.: US 2002/0181248 A1
(43) Pub. Date: Dec. 5, 2002

(54) Lighting display toy

(76) Inventor: Hung-Yi Chen, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/871,631

(22) Filed: Jun. 4, 2001

(51) Int. Cl. G02B 6/42; F21V 17/00

(52) U.S. Cl. 362/567; 362/581; 362/583

(57) ABSTRACT

A lighting display toy includes a light source, a plurality of light guide wire members adapted to guide light from the light source, the light guide wire members each having a first end aimed at the light source and a top end adapted to produce a light spot upon emission of light from the light source, and holder means adapted to hold the bottom end of each of the light guide wire members and to receive light from the light source.

### BACKGROUND OF THE INVENTION

The present invention relates to toys and, more particularly, to a lighting display toy that shows multiple light spots when turned on.

Ornamental display toys may be used to decorate a particular place when holding a birthday party or celebrating a particular day or holiday. In order to produce a lighting effect, ornamental display toys may be used with a light source. However, the lighting effect of conventional ornamental display toys having light source are less attractive because of monotonous light emitting mode.

### SUMMARY OF THE INVENTION

It is one object of the present invention to provide a lighting display toy, which is inexpensive to manufacture, and safe in use. It is another object of the present invention to provide a lighting display toy, which produces a variable lighting effect to attract people's eyes. According to one aspect of the present invention, the lighting display toy comprises a light source, a plurality of light guide wire members adapted to guide light from the light source, the light guide wire members each having a first end aimed at the light source and a top end adapted to produce a light spot upon emission of light from the light source, and holder means adapted to hold the bottom end of each of the light guide wire members and to receive light from the light source. According to another aspect of the present invention, a flower-like or tree-light ornamental device is fastened to the holder, and disposed around or surrounded by the light guide wire members.

### BRIEF DESCRIPTION OF THE DRAWINGS

FIG. 1 illustrates a lighting display toy according to a first embodiment of the present invention.

FIG. 2 illustrates a lighting display toy according to a second embodiment of the present invention.

FIG. 3 illustrates a lighting display toy according to a third embodiment of the present invention.

### DETAILED DESCRIPTION OF THE PREFERRED EMBODIMENT

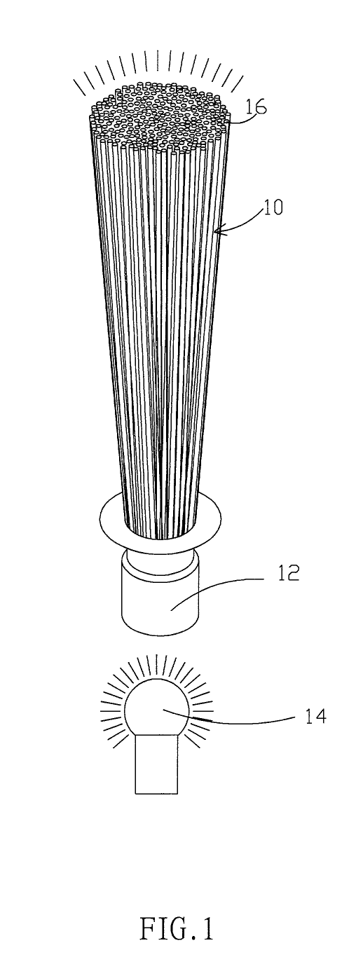

Referring to FIG. 1, a lighting display toy in accordance with one embodiment of the present invention is shown comprised of a holder 12, a bunch of light guide wire members 10, and a light source, for example, a lamp bulb 14. The light guide wire members 10 each have a top end and a bottom end. The bottom ends of the light guide wire members 10 are respectively inserted into the holder 12 from one side, namely, the topside of the holder 12. The lamp bulb 14 is disposed at the bottom side of the holder 12. When turning on the lamp bulb 14, light rays pass to the inside of the holder 12, and are guided from the bottom end of each of the t light guide wire members 10 to the to end, and therefore a plurality of light spots 16 are shown at the top ends of the light guide wire members 10. The light guide wire members 10 can be spiral wire members, coiled wire members, or wire members of any of a variety of shapes. The lamp bulb can be a colored lamp bulb. Further, the light guide wire members 10 can be transparent, or differently colored.

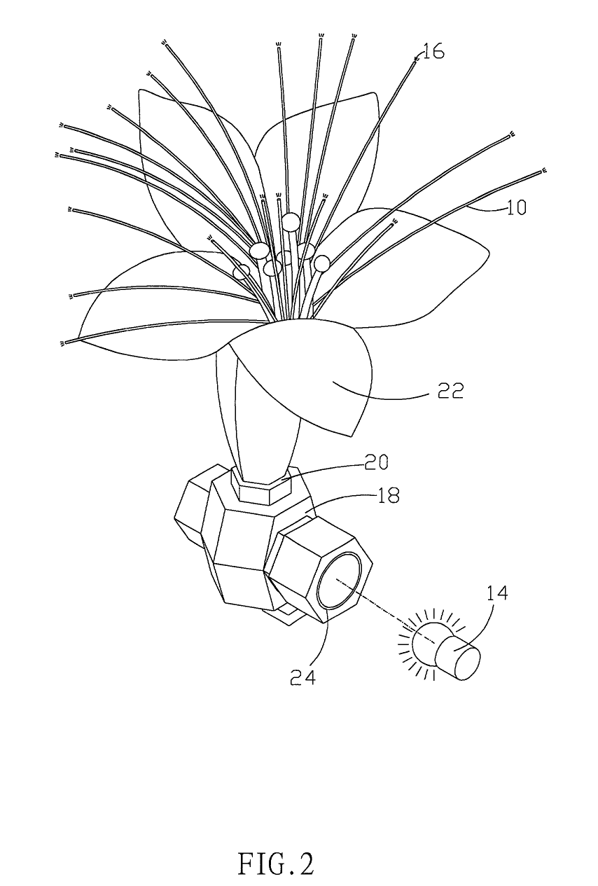

Referring to FIG. 2, a lighting display toy is shown comprised of a holder 18, a lamp bulb 14, a bunch of light guide wire members 10, and an ornamental device 22. The holder 18 comprises a horizontal hole 24, which receives light from the lamp bulb 14, and a top hole 20, which receives the ornamental device 22 and the light guide wire members 10 in the ornamental device 22. The bottom ends of the light guide wire members 10 are respectively fastened to the inside of the ornamental device 22. According to this embodiment, the ornamental device 22 is shaped like the receptacle of a flower, and the light guide wire members 10 are shaped like the stamens and pistils of the flower. When turning on the lamp bulb 14, light spots 16 are seen at the top ends of the light guide wire members 10.

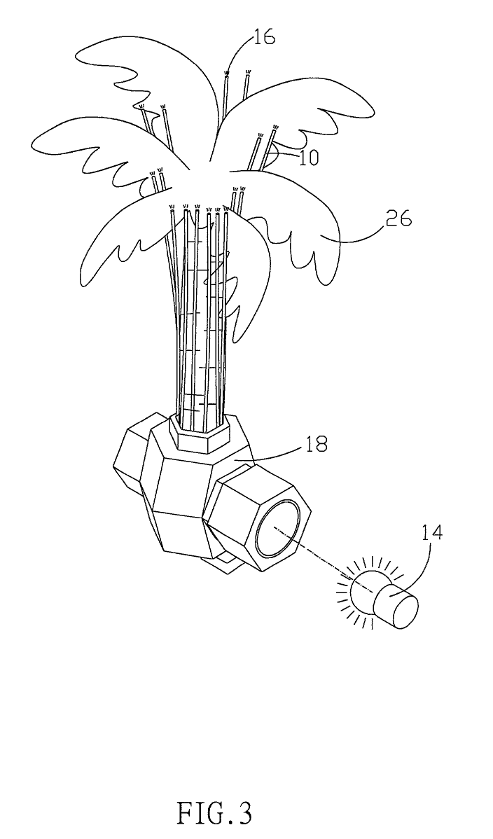

FIG. 3 shows a third embodiment of the present invention. According to this embodiment, the lamp bulb and the holder 18 are similar to the embodiment shown in FIG. 2, however the ornamental device 26 is shaped like a coconut tree. The light guide wire members 10 is fastened to the holder 18 and arranged around the ornamental device 26. When turning on the lamp bulb 14, light spots 16 are seen at the top ends of the light guide wire members 10.

A prototype of lighting display toy has been constructed with the features of FIGS. 1˜3. The lighting display toy functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A lighting display toy comprising a light source, and a plurality of light guide wire members adapted to guide light from said light source, said light guide wire members each having a first end aimed at said light source and a top end adapted to produce a light spot upon emission of light from said light source.

2. The lighting display toy of claim 1 further comprises holder means adapted to hold the bottom end of each of said light guide wire members and to receive light from said light source.

3. The lighting display toy of claim 1 wherein said light source is a colored lamp bulb.

4. The lighting display toy of claim 1 wherein said light guide wire members are respectively colored.

5. The lighting display toy of claim 1 wherein said light guide wire members each have a respective design.
